(19) United States
(12) Patent Application Publication
(10) Pub. No.: US 2024/0430334 A1
(43) Pub. Date: Dec. 26, 2024

(54) METHOD FOR STARTING UP PROGRAM PACKETS IN VEHICLES

(71) Applicant: Continental Automotive Technologies GmbH, Hannover (DE)

(72) Inventors: Carolin Hilbert, Regensburg (DE); Tereza Georgeta Bandino, Iasi (RO); Catalin-Cristian Ilie, Regensburg (DE)

(73) Assignee: Continental Automotive Technologies GmbH, Hannover (DE)

(21) Appl. No.: 18/699,275

(22) PCT Filed: Sep. 29, 2022
(86) PCT No.: PCT/DE2022/200227

§ 371 Date: Apr. 6, 2024

(30) Foreign Application Priority Data
Oct. 7, 2021 (DE) 10 2021 211 353.2

(51) Int. Cl. H04L 67/00; H04L 67/12

(52) U.S. Cl. CPC H04L 67/34; H04L 67/12

(57) ABSTRACT

The present disclosure relates to a method for starting up program packages in vehicles, in particular for starting up a new program package on at least one vehicle computing unit of a vehicle. The method includes the following steps: loading the program package from a central archive; storing the program package in a vehicle-specific archive; validating the program package in the vehicle-specific archive; determining the vehicle computing unit from a multiplicity of computing units of the vehicle; providing the validated program package on the vehicle computing unit; and starting the validated program package on the vehicle computing unit, wherein the program package performs a vehicle function.

### CROSS-REFERENCE TO RELATED APPLICATIONS

The present application is a National Stage Application under 35 U.S.C. § 371 of International Patent Application No. PCT/DE2022/200227 filed on Sep. 29, 2022, and claims priority from German Patent Application No. 10 2021 211 353.2 filed on Oct. 7, 2021, in the German Patent and Trademark Office, the disclosures of which are herein incorporated by reference in their entireties.

### TECHNICAL FIELD

The invention relates to a method for starting up program packages in vehicles, in particular for starting up a new program package on at least one vehicle computing unit of a vehicle. The invention further relates to a system, a vehicle, a program element, a computer-readable medium and a use.

### BACKGROUND

In many cases, vehicle functions are implemented statically in a vehicle during the manufacture of the vehicle and are often difficult to change. In at least some cases, a modification of a vehicle function requires visiting a workshop and/or replacing the hardware used to realize the vehicle function. This can be disruptive, in particular, when starting up a new program package would make it possible to improve the vehicle function and/or correct errors.

### SUMMARY

The object of the present disclosure is to provide a method which, in at least some cases, simplifies start-up of a new program package. This object is achieved by means of the subject matter of the independent patent claims. Developments of the present disclosure emerge from the subclaims and the following description.

One aspect relates to a method for starting up a new program package on at least one vehicle computing unit of a vehicle. The method includes the following steps:
loading the program package from a central archive;
storing the program package in a vehicle-specific archive;
validating the program package in the vehicle-specific archive;
determining the vehicle computing unit from a multiplicity of computing units of the vehicle;
providing the validated program package on the vehicle computing unit; and
starting the validated program package on the vehicle computing unit,
   wherein the program package performs a vehicle function.

The vehicle is, for example, a motor vehicle, such as an automobile, a bus or a truck, or else a rail vehicle, a ship, an aircraft, such as a helicopter or an airplane. A vehicle computing unit (Vehicle Computing Platform, VCP) is a processor (“general-purpose processor”), a controller, dedicated hardware, e.g., with firmware, and/or other types of computing units. A program package is a file that can be executed, interpreted and/or compiled on at least one of the vehicle computing units. The program package can be compressed and/or encrypted. Start-up can include downloading and providing (deploying) the program package. Starting up the program package means that at least one of the vehicle computing units can perform one or more vehicle functions. The performance of the vehicle functions can begin immediately after the program package has been transmitted to the vehicle computing unit (i.e. to a target computing unit), but it can also be started only at a later time.

The new program package can implement, for example, an already existing or similar vehicle function (“update”), e.g., as part of an improvement in performance and/or an error correction. The new program package can add, for example, one or more new vehicle functions (“upgrade”). In at least some cases, updates can be loaded “automatically”, that is to say controlled by central service personnel, for example. In at least some cases, upgrades can be requested and/or approved by a user, e.g., by a driver of the vehicle, a leasing provider, etc. At least some vehicle functions can belong to both categories, e.g., a new navigation system. For example, the user can reject or postpone optional function updates. Mandatory updates can be installed automatically. For new vehicle functions, the function can be deployed on a VCP at the time at which the function is intended to be started for the first time.

The program packages for a vehicle can be supplied by one or more manufacturers. After supply, the program packages can be stored in a central archive (online repository). The program package can be loaded from the central archive via a cable connection and/or in a cable-free manner (wirelessly). Loading the program package from the central archive can be an optional step, i.e., at least some program packages can already be pre-installed on the vehicle, e.g., during manufacture. The program package or the program packages may be wirelessly transmitted e.g. by Bluetooth, WLAN (e.g. WLAN 802.11a/b/g/n or WLAN 802.11p), ZigBee or WiMax or else cellular radio systems such as GPRS, UMTS, or LTE and/or 5G. Alternatively or additionally, the use of other transmission protocols is also possible.

Once the program package has been loaded, it can be stored in a vehicle-specific archive (in-vehicle repository). Storage may include decompression, decryption, compiling, and/or adaptation to the vehicle. The vehicle-specific archive may have facilities for validating the program package; this may include verification and/or testing, e.g., by means of authentication of the program package, regression tests, simulation of interfaces and/or system calls and/or more. These facilities can be available permanently or on demand; for example, regression tests can be supplied with the program package. For cases in which the program package cannot be executed on a computing unit of the vehicle-specific archive (the “archive processor”)—e.g., because the target hardware is a different processor type—the vehicle-specific archive can provide means for simulation and/or emulation.

The determination of the vehicle computing unit (target computing unit) from a multiplicity of computing units of the vehicle may include an analysis of the target computing unit, the current processor load, the program package and/or other aspects. As a result of determining the target computing unit, the validated program package is provided on the target vehicle computing unit (deployment).

After the program package has been provided, the program package can be started on the vehicle computing unit, with the result that the program package performs a vehicle function. It can be started immediately, or only after a predetermined event. For example, a “fail-operational function” (switch to a backup system in the event of an error) and/or a “fall-back function” (switch to a backup system in the event of an error, in at least some cases associated with a downgrading of the original function) can first be loaded on a backup processor, and only activated or started in the event of an error. In this way, for example, a so-called “hot swap” can be implemented in the event of an error.

The method advantageously provides a framework that simplifies the start-up of a new program package and also makes this faster and safer. Furthermore, the method can be used for a multiplicity of applications. The following list presents some illustrative applications:
An enhanced child safety device on the rear doors can prevent, for example, the window lifters from being actuated in order to prevent small children from becoming trapped.
An enhanced navigation system may include, for example, specific features such as clearance heights, a higher resolution of certain routes and/or predefined colors. This can also be offered as a chargeable feature, and start-up and/or delivery can be linked to a payment system.
For certain overload functions and/or failures of a vehicle computing unit, a functionally reduced (fall-back) function can be available, which is provided on a target vehicle computing unit and is activated in the event of an incident.

Furthermore, this can contribute to reducing the hardware dependency of vehicle functions through the common “middleware” and through a framework that can support multiple hardware platforms. Furthermore, a dynamic deployment and redeployment of vehicle functions can be supported by a vehicle computing unit. This can facilitate the installation of new vehicle applications and/or the updating of existing functions without the need for service personnel or a workshop every time. This can also be a basis for new business models, such as “pay per function”, “pay per function usage”, etc. The method can provide a basis for optimizing resource utilization, e.g., computing and/or network resources, energy consumption, etc., and/or improving the runtime of the vehicle computing units, for example because only those computing units which are actually required for a particular application are loaded. In addition, means can be provided for a consistent redundancy concept, e.g., for “fail-safe” or “fail-operational” functions.

In some embodiments, the validation of the program package includes an emulation of functions that are not executable on an archive processor of the vehicle-specific archive. For example, the target vehicle computing unit may be a different processor type or hardware type than the processor (“archive processor”) of the vehicle-specific archive. For example, the target vehicle computing unit may include or have dedicated hardware, a different processor type, other interfaces (e.g., ioctl) and/or more, with the result that the program package is not easily executable on the archive processor. The hardware dependencies can be significantly reduced by simulating and/or emulating functions.

In some embodiments, the loading of the program package is triggered by a request from a user, by a request from an assignment and monitoring unit and/or by version control. The user can be, for example, the driver, a leasing provider, a workshop and/or other persons and/or institutions. For example, the user can be a monitoring program that automatically loads a corrected program package if critical errors are detected, for example. For example, the user can be version control to optimize certain functions.

In some embodiments, the determination of the vehicle computing unit is controlled by a list of criteria including:
determining a type of the vehicle computing unit;
determining a function of the vehicle computing unit;
determining a computing power of the vehicle computing unit;
determining a memory size and/or memory performance of the vehicle computing unit; and/or
determining an energy consumption of the vehicle computing unit.

This means that a dynamic function assignment is carried out, i.e., a decision on the target vehicle computing unit for the new vehicle function and/or the function update on the basis of an assignment algorithm, taking into account functional dependencies and use restrictions of the function.

The determination of a type of the vehicle computing unit may include determining, for example, the hardware of the vehicle computing unit. When determining a function of the vehicle computing unit, the function can be, for example, controlling window lifters or an infotainment function.

The determination of a computing power of the vehicle computing unit can include, for example, comparing the current power, the maximum power and/or a history of the power of other processors. This may result, for example, in an (e.g. temporary) downgrading of the function and/or may include a selection of an alternative function. It may include an analysis of a stay-alive signal. It may include detecting an error and/or marking a faulty vehicle computing unit as unavailable.

Determining a memory size and/or memory performance of the vehicle computing unit can concern, for example, throughput and/or latency.

In some embodiments, the determination of the vehicle computing unit includes a selection of an alternative function of the program package. The alternative function can be part of the program package, or another function, such as an older function, for example in the event of an error after a new function has been newly installed, e.g., precisely on this vehicle.

In some embodiments, the determination of the vehicle computing unit and/or the provision of the validated program package include(s) storing information about the program package in a vehicle register (Global Function Registry). This means that an overview of the current functions and/or software versions (etc.) can be provided centrally at any time.

In some embodiments, the method further includes stopping and/or uninstalling the vehicle function on another vehicle computing unit; or stopping and optionally uninstalling the vehicle function. The vehicle function can be a bundle of selected functions. This makes it possible to relieve the load on the other vehicle computing unit. This can advantageously be used, for example, in the event of an error and/or high load (overload) and/or for optimization (resource optimization scenario).

In one embodiment, the stopping of the vehicle function of another vehicle computing unit involves evaluating the criticality of the vehicle function. This allows critical functions to be started on another processor, for example. For example, non-critical functions can be stopped—at least for a predefined period of time.

In some embodiments, the starting of the validated program package on the vehicle computing unit is controlled by means of a start trigger. Examples can be start triggers that only take effect in the event of an overload or error.

In some embodiments, the loading of the program package, the storing of the program package, the validation of the program package, the provision of the validated program package and/or the starting of the validated program package involve(s) an authentication of this action. This can be realized, for example, with cryptographic methods. This advantageously increases security against impermissible access to vehicle functions.

One aspect relates to a program element which, when executed on one or more computing units of a vehicle system of a vehicle and/or on another computing unit, instructs the at least one computing unit to carry out the method as described above and/or below.

One aspect relates to a computer-readable medium on which the program element described here is stored.

One aspect relates to a vehicle system for starting up a new program package on at least one vehicle computing unit of a vehicle. The vehicle system has a vehicle-specific archive (in-vehicle repository) configured to store a program package from the multiplicity of program packages and to validate the program package. The vehicle-specific archive can be viewed as a local application server in the vehicle.

Furthermore, it has a multiplicity of vehicle computing units (Vehicle Computing Platform, VCP) configured to execute vehicle-specific commands. These commands can be sent from a CAM (see below) and can include, for example, functions such as starting, stopping and/or restarting one or more functions, sending the ECU alive status, and/or others. The vehicle computing unit may be a general processor (Electronic Control Unit, ECU), a multiprocessor, dedicated hardware, may include interfaces, buses and/or network components, and/or may be suitable for various levels of real-time requirements. The VCP can send activity signals (alive status). The VCP can receive and process control functions such as start, stop, restart, etc.

The vehicle system further includes an assignment and monitoring unit (Central Allocation Manager, CAM) configured to determine the vehicle computing unit from the multiplicity of computing units of the vehicle, to provide the validated program package on the vehicle computing unit, and to start the validated program package on the vehicle computing unit. The assignment and monitoring unit can be designed as a central component or control unit in the vehicle and/or can be designed as a redundant component. The assignment and monitoring unit can manage the dynamic deployment and redeployment of vehicle functions and vehicle function updates. Furthermore, all control units are thus monitored with regard to resource consumption and use as well as control unit failures. Furthermore, this component detects hardware failures, resource overloads and performs load balancing for each control unit by means of dynamic function reallocation, i.e., the redistribution of functions.

In some embodiments, the assignment and monitoring unit is further configured to monitor the vehicle computing units, in particular to detect hardware errors, to detect overload, and/or to implement load balancing by transferring sub-functions.

In addition, the assignment and monitoring unit may further include a vehicle register (Global Function Registry) including information relating to which vehicle function is assigned to which vehicle computing unit (deployed). The vehicle register may contain information about which functions have not yet been activated and/or about which functions can be considered to be a substitute function and/or a “degraded” function of another function—which is activated, for example, on another vehicle computing unit.

In some embodiments, the vehicle-specific archive includes a test unit which is configured to test, to simulate and/or to emulate vehicle functions. The test unit can “know” interfaces and/or system calls of the program package, i.e., can be able to process them—e.g., by means of simulation and/or emulation—especially if the program package cannot be executed on an archive processor. The program package may include a test package and/or other files based on the program package and/or the test package.

One aspect relates to a system for starting up a new program package on at least one target processor of a vehicle. The system has a central archive (online repository) configured to store a multiplicity of program packages for a vehicle, and a vehicle system as described above and/or below. The program packages can come from one or more suppliers.

One aspect relates to a vehicle with a vehicle system as described above and/or below.

One aspect relates to the use of a vehicle system as described above and/or below, or of a system as described above and/or below, for starting up a new program package on at least one vehicle computing unit of a vehicle, for updating, for upgrading, for load balancing and/or for correcting errors of at least one vehicle function.

It should also be noted that the different embodiments can be combined with each other.

For further clarification, the present disclosure will be described on the basis of embodiments shown in the figures. These embodiments are intended to be understood merely as an example and not as a limitation.

### BRIEF DESCRIPTION OF THE DRAWINGS

Here:

FIG. 1 schematically shows a system according to one embodiment;

FIG. 2 schematically shows a vehicle system according to one embodiment; and

FIG. 3 shows a flowchart with a method according to one embodiment.

### DETAILED DESCRIPTION

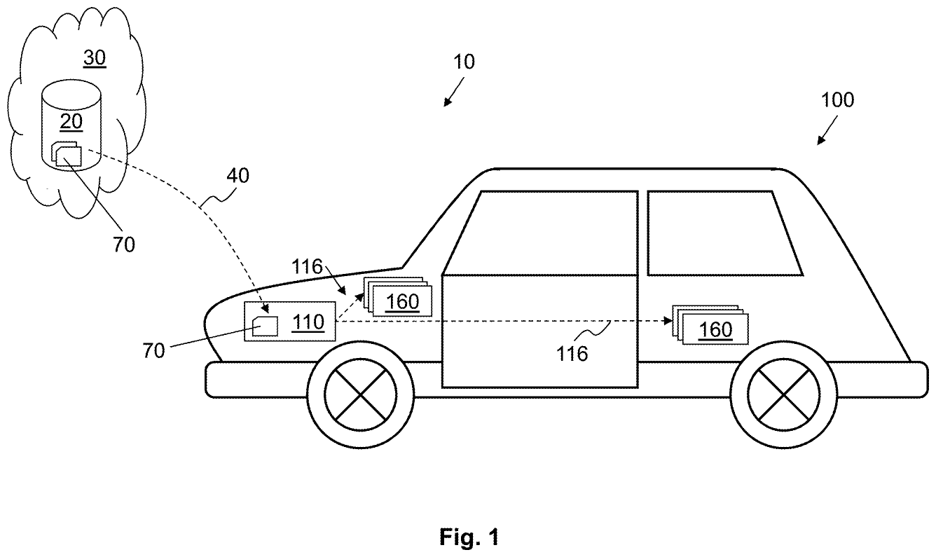

FIG. 1 schematically shows a system 10 according to one embodiment. The system 10 is configured to start up a new program package 70 on at least one target processor of a vehicle 100. The program package 70 can initially be stored on a central archive (online repository) 20. The central archive can be configured to store a multiplicity of program packages 70 for a vehicle 100. The program packages for a vehicle can be supplied by one or more manufacturers. The central archive can be arranged on a server, a database and/or in a cloud 30. The program package 70 can be transmitted, for example, via a transmission channel 40 to a vehicle system 110; this can be done via a cable connection and/or in a cable-free manner (wirelessly). The vehicle system 110 transmits the program package 70 to one or more vehicle computing units (Vehicle Computing Platform, VCP) 160 by means of a transmission and monitoring channel 116.

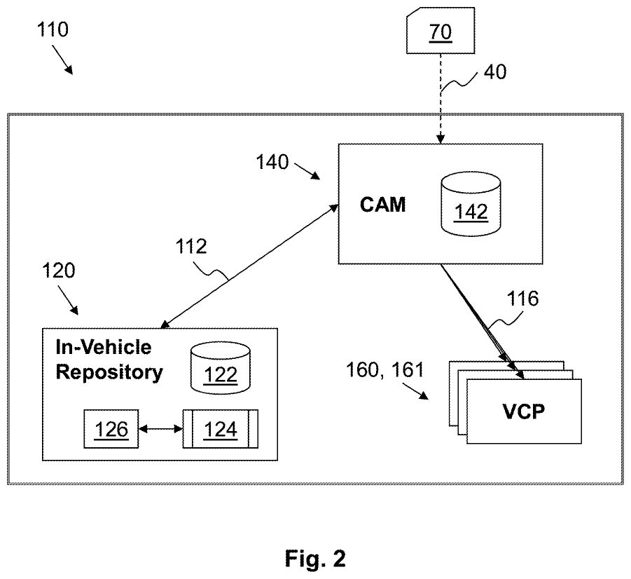

FIG. 2 schematically shows a vehicle system 110 according to one embodiment. The vehicle system 110 loads a program package 70, e.g., from a central archive 20 (see FIG. 1), and stores the program package 70, e.g., via a transmission channel 112, in a vehicle-specific archive (in-vehicle repository) 120, e.g., in a memory 122. The transmission may involve unpacking, decryption and/or other actions. The program package 70 can be tested in the vehicle-specific archive 120, e.g., by means of an archive processor 126, on a test unit 124. In cases in which the program package 70 cannot be executed or can only be partially executed on the archive processor 126, the interfaces, system calls, etc. can be simulated and/or emulated. An assignment and monitoring unit (Central Allocation Manager, CAM) 140 can then determine a vehicle computing unit VCP 160 from a multiplicity of computing units 160, 161 of the vehicle 100, to which the validated program package 70 is transmitted via a transmission and monitoring channel 116. Subsequently, or at a later time, the program package 70 can be started on the vehicle computing unit 160, and thus the program package 70 can perform a vehicle function.

The assignment and monitoring unit 140 can also be configured to monitor the vehicle computing units 160, in particular to detect hardware errors, to detect overload, to implement load balancing by transferring sub-functions, and/or other central functions. Furthermore, the assignment and monitoring unit 140 may include a vehicle register 142 including information relating to which vehicle function is assigned to which vehicle computing unit 160, performs this function, the extent to which the vehicle computing unit 160 is utilized, and/or whether the vehicle computing unit 160 is functional.

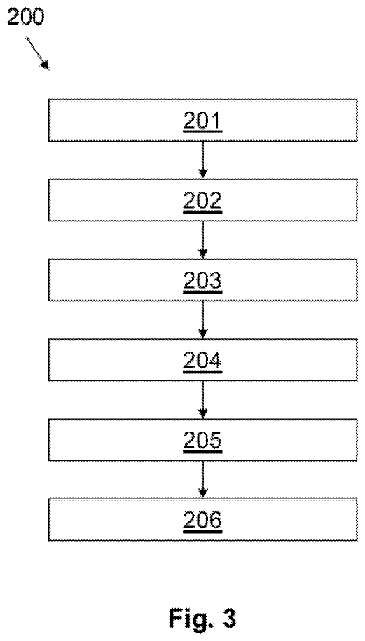

FIG. 3 shows a flowchart 200 with a method according to one embodiment. In a step 201, a program package 70 (see FIG. 1 or 2) is loaded from a central archive 20. Step 201 can be optional; it is possible, for example, for at least some program packages 70—e.g. program packages for a failover function and/or another error-compensating function—to have already been installed in the vehicle during manufacture. In a step 202, the program package 70 is stored in a vehicle-specific archive 120. In a step 203, the program package 70 is tested in the vehicle-specific archive 120. In a step 204, the vehicle computing unit 160 is determined from a multiplicity of computing units 160, 161 of the vehicle 100. In a step 205, the validated program package 70 is provided on the vehicle computing unit 160. In a step 206, the validated program package 70 is started on the vehicle computing unit 160, wherein the program package 70 performs one or more vehicle functions.

### LIST OF REFERENCE SIGNS

10 System
20 Central archive (online repository)
30 Cloud
40 Transmission channel
70 Program package
100 Vehicle
110 Vehicle system
112 Transmission channel
116 Transmission and monitoring channel
120 Vehicle-specific archive (in-vehicle repository)
122 Memory
124 Test unit
140 Assignment & monitoring unit (Central Allocation Manager, CAM)
142 Vehicle register (Global Function Registry)
160, 161 Vehicle computing unit (Vehicle Computing Platform, VCP)
126 Archive processor
200 Flowchart
201-206 Steps

1. A method for starting up a new program package on at least one vehicle computing unit of a vehicle, the method comprising:
loading the program package from a central archive;
storing the program package in a vehicle-specific archive;
validating the program package in the vehicle-specific archive;
determining a vehicle computing unit from a multiplicity of computing units of the vehicle;
providing the validated program package on the vehicle computing unit; and
starting the validated program package on the vehicle computing unit, wherein the program package performs a vehicle function.

2. The method as claimed in claim 1, wherein the validation of the program package comprises a simulation and/or emulation of functions that are not executable on an archive processor of the vehicle-specific archive.

3. The method as claimed in claim 1, wherein the loading of the program package is triggered by at least one of a request from a user, a request from an assignment and monitoring unit, or version control.

4. The method as claimed in claim 1, wherein the determination of the vehicle computing unit is controlled by a list of criteria comprising at least one of:
determining a type of the vehicle computing unit;
determining a function of the vehicle computing unit;
determining computing power of the vehicle computing unit;
determining at least one of memory size and/or memory performance of the vehicle computing unit; or
determining energy consumption of the vehicle computing unit.

5. The method as claimed in claim 1, wherein the determination of the vehicle computing unit comprises a selection of an alternative function of the program package.

6. The method as claimed in claim, 1 wherein at least one of the determination of the vehicle computing unit or the provision of the validated program package comprise(s) storing information about the program package in a vehicle register.

7. The method as claimed in claims 1, further comprising:
at least one of stopping or uninstalling the vehicle function on another vehicle computing unit.

8. The method as claimed in claim 7, wherein the stopping of the vehicle function of another vehicle computing unit comprises evaluating a criticality of the vehicle function.

9. The method as claimed in claims 1, wherein the starting of the validated program package on the vehicle computing unit is controlled by a start trigger.

10. The method as claimed in claims 1, wherein at least one of the loading of the program package, the storing of the program package, the testing of the program package, the provision of the validated program package or the starting of the validated program package involve(s) an authentication.

11. A program element which, when executed on one or more computing units of a vehicle system of a vehicle and/or on another computing unit, instructs the at least one computing unit to carry out the method as claimed in claim 1.

12. A computer-readable medium on which a program element as claimed in claim 11 is stored.

13. A vehicle system configured to start up a new program package on at least one vehicle computing unit of a vehicle, the vehicle system comprising:
a vehicle-specific archive configured to store a program package from a multiplicity of program packages and to test the program package;
a multiplicity of vehicle computing units configured to execute vehicle-specific commands; and
an assignment and monitoring unit configured to determine the vehicle computing unit from the multiplicity of computing units of the vehicle, provide the validated program package on the vehicle computing unit, and start the validated program package on the vehicle computing unit.

14. The vehicle system as claimed in claim 13,
wherein the assignment and monitoring unit is further configured to at least one of monitoring the vehicle computing units, or implementing a fail-operational concept by transferring sub-functions, and/or
wherein the assignment and monitoring unit further comprises a vehicle register comprising information relating to which vehicle function is assigned to which vehicle computing unit from the multiplicity of computing units.

15. The vehicle system as claimed in claim 13, wherein the vehicle-specific archive comprises a test unit which is configured to at least one of test, simulate or emulate vehicle functions.

16. A system for starting up a new program package on at least one target processor of a vehicle, the system comprising:
a central archive configured to store a multiplicity of program packages for a vehicle; and
a vehicle system as claimed in claim 13.

17. A vehicle with a vehicle system as claimed in claim 13.

18. The use of a vehicle system as claimed in claim 13, for starting up a new program package on at least one vehicle computing unit of a vehicle, for at least one of updating, upgrading, load balancing correcting errors or implementing a fail-operational concept of at least one vehicle function.

19. The vehicle system of claim 13, wherein the assignment and monitoring unit is further configured to at least one of monitoring the vehicle computing units, or implementing a fail-operational concept by transferring sub-functions.

20. The vehicle system of claim 13, wherein the assignment and monitoring unit further comprises a vehicle register comprising information relating to which vehicle function is assigned to which vehicle computing unit from the multiplicity of computing units.
